(19) United States
(12) Patent Application Publication
(10) Pub. No.: US 2016/0279003 A1
(43) Pub. Date: Sep. 29, 2016

(54) CHAIR FOR PERSON TRANSFER

(71) Applicant: Sauder Manufacturing Co., Archbold, OH (US)

(72) Inventors: Donald E. Newfer, Auburn, IN (US); Martin J. Krause, Fort Wayne, IN (US); Steven Stieglitz, Harlan, IN (US)

(73) Assignee: Sauder Manufacturing Co., Archbold, OH (US)

(21) Appl. No.: 14/666,854

(22) Filed: Mar. 24, 2015

(51) Int. Cl. A61G 5/12; A47C 7/54

(52) U.S. Cl. CPC A61G 5/12; A47C 7/543; A61G 2005/125

(57) ABSTRACT

A chair for person transfer comprises a base, supporting sides disposed on opposing sides of the base, which stand substantially perpendicular from the base, a chair seat extending perpendicularly between the each supporting sides and a chair back extending substantially perpendicularly from the rear of seat. At least one of the supporting sides includes an arm base and an arm rest rotatably connected to the arm base. The arm rest is rotatable between a closed position where an arm rest lower surface abuts the arm base and an open position where the arm rest is disposed substantially behind the chair back

### BACKGROUND

Conventionally, chairs which are used in environments such as convalescent homes, nursing homes, hospitals, or the like require a person using the chair to be transferred laterally to another device such as a wheelchair or bed. The arm rests on such chairs form an obstacle when transferring a person laterally from the chair to another device. Chairs with movable arm rests to aid in person transferring typically require additional clearance between the chair and the transfer device, causing secondary moving of the chair or transfer device after the arm rest is moved.

### BRIEF SUMMARY

According to an embodiment of the invention, a transfer chair includes a base, supporting sides disposed on opposite sides of the base and which extend upward from the base, a chair seat extending between the supporting sides, and a chair back extending upwardly from a rear of seat. At least one of the supporting sides has an arm base securely fastened to the base with an arm base upper surface disposed beneath a top surface of the seat. It also has an arm rest with an arm rest lower surface. The arm rest is rotatably mounted to the arm base such that the arm rest may be selectively rotated in the same plane as the arm base between a closed position where the arm rest lower surface engages the arm base upper surface, and a fully open position where the arm rest lower surface is disposed behind a front surface of the chair back.

### BRIEF DESCRIPTION OF THE DRAWINGS

In the drawings:

FIG. 1 is a perspective view of a chair having an arm rest in a closed position according to an embodiment of the invention.

FIG. 2 is a perspective view of the chair of FIG. 1 with the arm rest in a rotation indicating position according to an embodiment of the invention.

FIG. 3 is a perspective view of the chair of FIG. 1 with the arm rest in at least a partially open position according to an embodiment of the invention.

FIG. 4 is an exploded view of the supporting side of FIG. 1 according to an embodiment of the invention.

FIG. 5 is a sectional view of the supporting side of FIG. 4 with the arm rest in a closed position according to an embodiment of the invention.

FIG. 6 is a sectional view of the supporting side of FIG. 4 with the arm rest in the rotation indicating position according to an embodiment of the invention.

FIG. 7 is a sectional view of the supporting side of FIG. 4 with the arm in the open position according to an embodiment of the invention.

### DETAILED DESCRIPTION

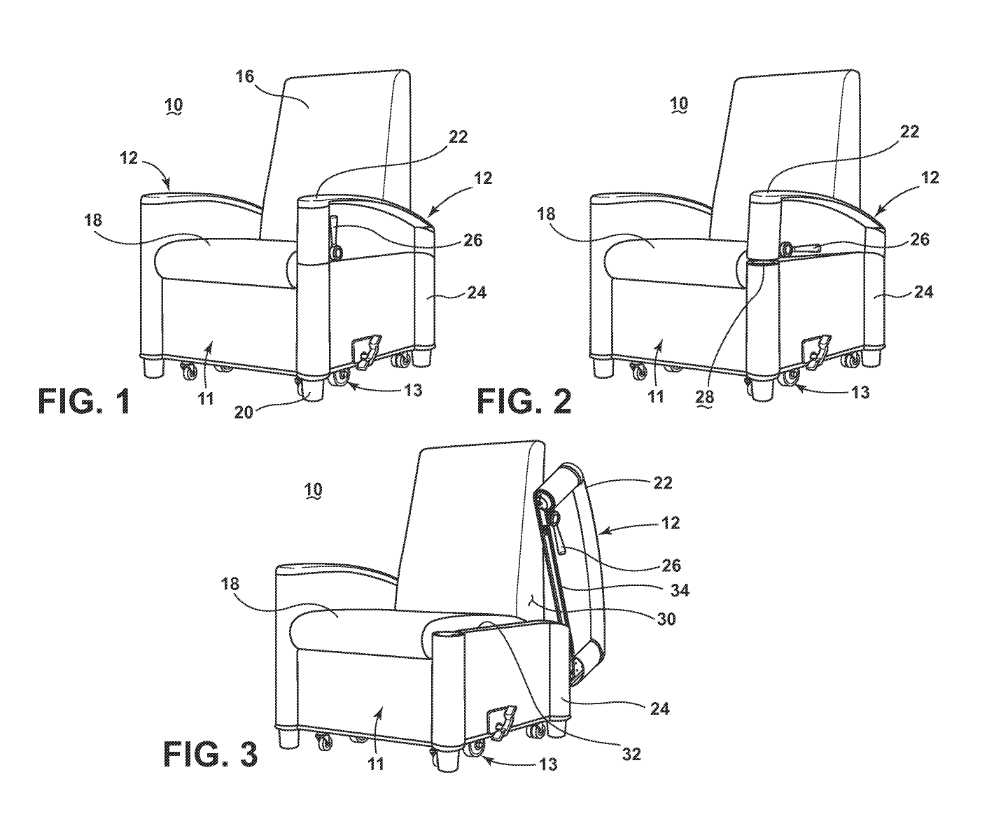

Turning to the drawings and to FIG. 1 in particular, there is shown a chair 10 comprising a base 11, supporting sides 12 disposed on opposing sides of the base 11, which extend upward from the base 11, preferably standing substantially perpendicular from the base 11, a chair seat 18 extending between the supporting sides 12, and a chair back 16 extending upwardly from a rear of seat 18. Mounted to the base 11 is a caster system 13 which movably supports the chair 10 on a ground surface and decorative chair legs 20 to at least partially obscure the caster system 13 from view.

One or both of the supporting side arms 12 includes an arm base 24 defining a lower portion of the supporting sides 12 and an arm rest 22 defining an upper portion of the supporting sides 12. The arm base 24 is securely fastened to the base 11 and the arm rest 22 is rotatably mounted to the arm base 24 such that the arm rest 22 may be selectively rotated with respect to the arm base 24.

A latching mechanism 15 having a first portion disposed in the arm rest 22 and a second portion disposed in the arm base 24 is provided in the supporting side arms 12 to selectively secure the arm base 24 and arm rest 22 together at the front portion thereof. The arm rest 22 is provided with a lever 26 operably coupled to the latching mechanism 15 to selectively allow the arm rest 22 to rotate about the arm base 24. When the lever 26 is in a first or closed position as illustrated in FIG. 1, the first portion of the latching mechanism 15 in the arm rest 22 is securely engaged with the second portion of the latching mechanism 15 in the arm base 24 at a front portion thereof to prevent rotation of the arm rest 22, defining an engaged position of the supporting side 12.

When the lever 26 is rotated to a second position as illustrated in FIG. 2, the first portion of the latching mechanism 15 disengages the second portion of the latching mechanism 15, decoupling the arm rest 22 and the arm base 24 at a front portion thereof. When initially disengaged, the arm rest 22 moves to a rotation indicating position wherein an indicating gap 28 is formed between the arm rest 22 and the arm base 24 at a front portion thereof. The rotation indicating position indicates that the arm rest 22 is disengaged from the arm base 24 and that the arm rest 22 may be rotated about the arm base 24.

When disengaged from the arm base 24, the arm rest 22 may be rotated about the arm base 24 at a rear portion thereof toward a fully open position as illustrated in FIG. 3. When in the fully open position, an arm base upper surface 32 is disposed beneath a top surface of the seat 18 and an arm rest lower surface 34 is disposed behind a front surface of the chair back 16, forming a transfer gap 30 between the arm base 24 and the arm rest 22. During rotation, the arm rest 22 remains in the same vertical plane as the arm base 24. When in the fully open position, a person seated in the chair 10 may be transferred to another device, such as a wheelchair, by moving laterally over the arm base 24 through the transfer gap 30.

To reengage the arm rest 22 with the arm base 24, the arm rest 22 may be rotated until the arm rest lower surface 34 is in contact with the arm base upper surface 32 and the lever 26 may be rotated to the first position, engaging the first and second portions of the latching mechanism 15.

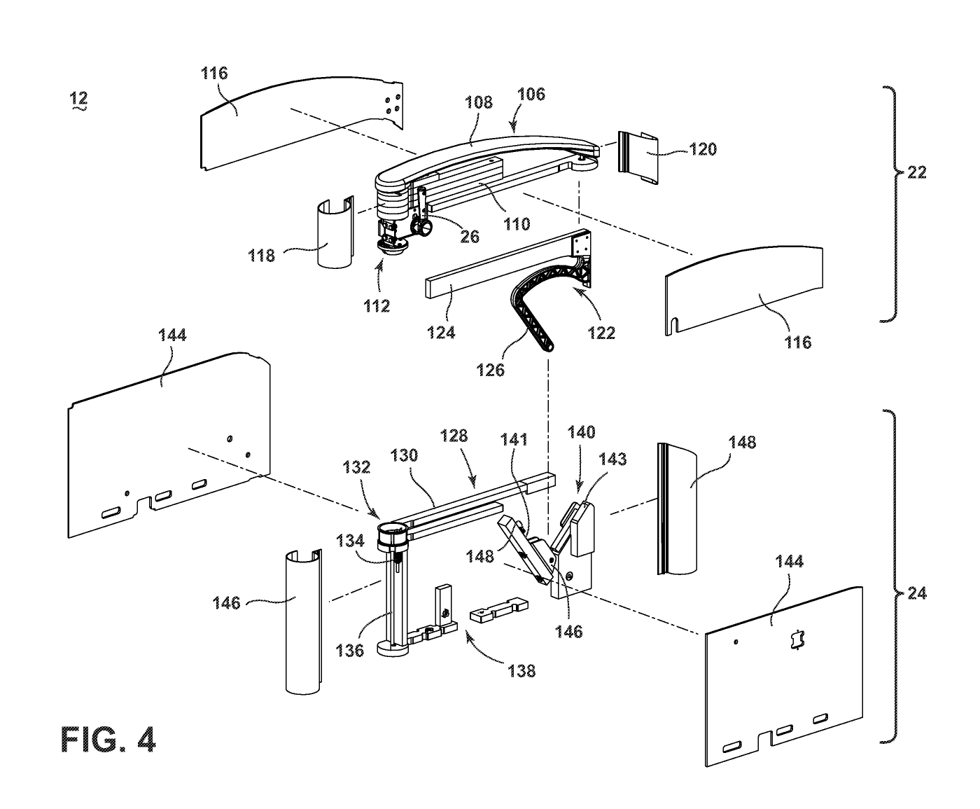

Referring now FIG. 4, there is shown an exploded view of a supporting side 12. The supporting side 12 comprises the arm rest 22, the arm base 24 and a pivoting connecting member 122. The arm rest 22 comprises an upper frame member 106, a latching mechanism upper portion 112 operably connected to the lever 26, side arm panels 116, an upper front cover 118 and an upper rear cover 120. The side arm panels 116, an upper front cover 118 and an upper rear cover 120 are attached to and surround the upper frame member 106. The upper frame member 106 includes an arcuate upper support 108 with supporting members 110 extending between opposing ends of the arcuate upper support 108. The pivoting connecting member 122 has a horizontal member 124 attached to a connecting arm 126. The horizontal member 124 on the pivoting connecting member 122 is preferably securely fastened to the supporting member 110 such that the bottom surface of the horizontal member 124 may define the arm rest lower surface 34. It will be understood that the arm rest lower surface 34 may be defined by other structure, such as by a frame surrounding the horizontal member 124 or by the side arm panels 116. It sufficient to define the arm rest lower surface 34 as any structure of the arm rest 22 in a plane that contacts the arm base upper surface 32 in the closed position.

The arm base 24 comprises a lower frame portion 128, a latching mechanism lower portion 132, side base panels 144, a lower front cover 146 and a lower rear cover 148. The side base panels 144, lower front cover 146 and lower rear cover 148 attach to and surround the lower frame portion 128. The lower frame portion 128 includes a horizontal frame rail 130 having an upper surface defining the arm base upper surface 32, a vertical frame rail 136 and lower frame members 138. The latching mechanism lower portion 132 may be provided with a retention spring 134 to provide a downward spring force on the latching member upper portion 112 when engaged with the latching member lower portion 132. The retention spring 134 thus biases the arm rest 22 toward the closed position. The arm base 24 is further provided with a pivot arm retainer 140 having a closed position stop surface 141, an open position stop surface 143 and a pivot axis 146. A biasing spring 148 is provided on the closed position retaining surface 142.

The lower portion of the connecting arm 126 on the pivoting connecting member 122 connects to the pivot axis 146 on the pivot arm retainer 140 to rotatably connect the arm rest 22 to the arm base 24. When connected, the pivoting connecting member 122 may rotate about the pivot axis 146 between the closed position where the connecting arm 126 compresses the biasing spring 148 and nearly abuts the closed position stop surface 141 and the fully open position where the connecting arm 126 abuts the open position stop surface 143.

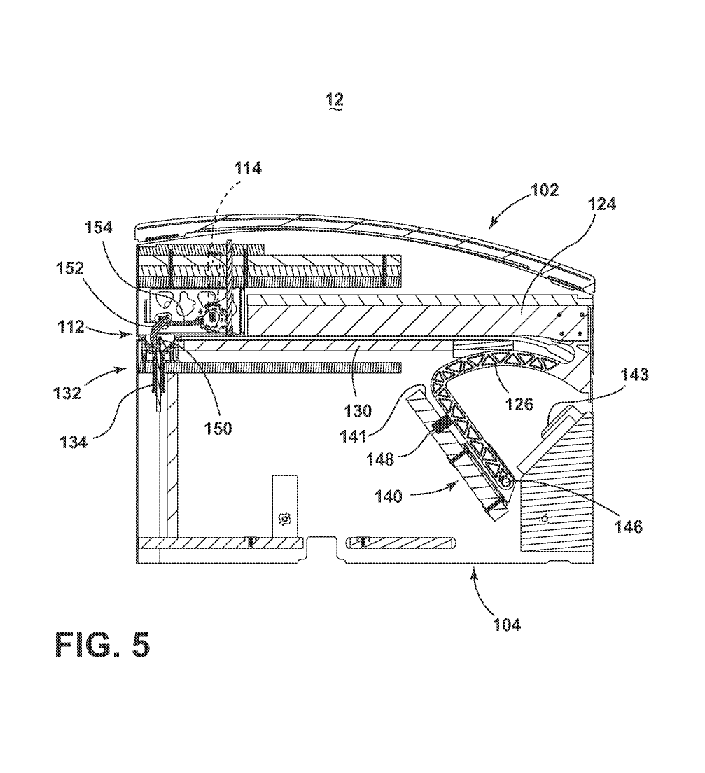

FIG. 5 shows a sectional view of the supporting side 12 in the closed position. The latching mechanism upper portion 112 includes a pivoting hook 152 operably connected to the lever 26 via a connecting rod 154. The latching mechanism lower portion 132 included an eyelet 150 attached to the retention spring 134. When the lever 26 is in the engaged position as illustrated, the hook 152 engages the eyelet 150 to secure the arm rest 22 and arm base 24 together. The retention spring 134 provides a downward force on the eyelet 150 and in turn, the hook 152 to provide a downward force, or latch force, on the arm rest 22. The spring force of the retention spring 134 may be adjustable to vary the latch force. In one embodiment, the latch force may be in the range of 150 lbs to 250 lbs.

When in the closed position, the horizontal member 124 of the connecting member 122 abuts the horizontal frame rail 130 of the lower frame portion 128 and the connecting arm 126 abuts the closed position retaining surface 141, compressing the biasing spring 148. In this way, the biasing spring 148 provides an upward force on the connecting arm 126 such that the upward force is overcome by a user providing a downward force on the arm rest 22 to engage the latching mechanism upper portion 112 and latching member lower mechanism 132.

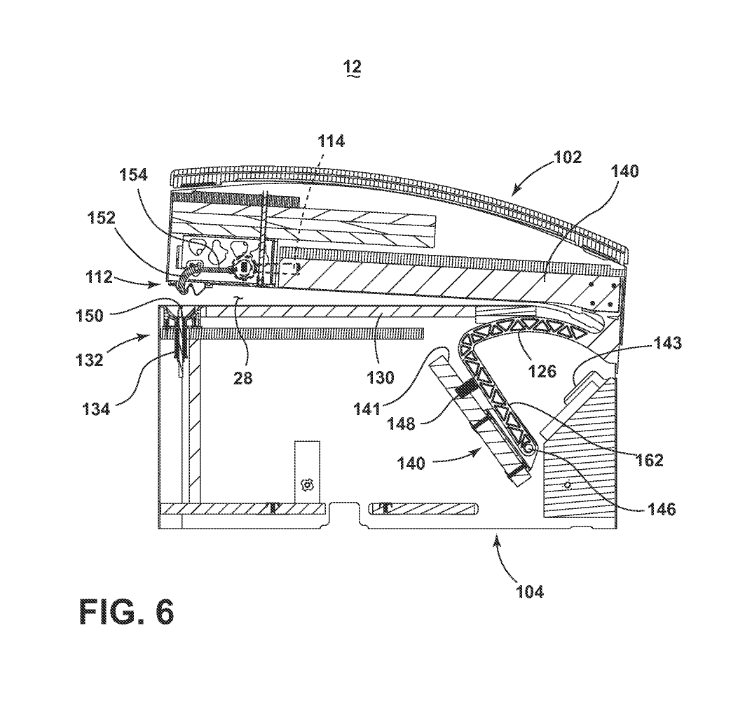

When the lever 26 is moved to the second position or disengaged position as illustrated in FIG. 6, the hook 152 pivots upwardly and outwardly to disengage the eyelet 152. Once disengaged, the upward force of the biasing spring 148 exerted on the connecting arm 126 pivots the arm rest 22 about the pivot axis connector 146 to form the indicating gap 28 between the upper arm base upper surface 32 and arm rest lower surface 34. The indicating gap 28 serves to alert a user that the arm rest 22 is disengaged from the arm base 24 and is freely rotatable about the arm base 24.

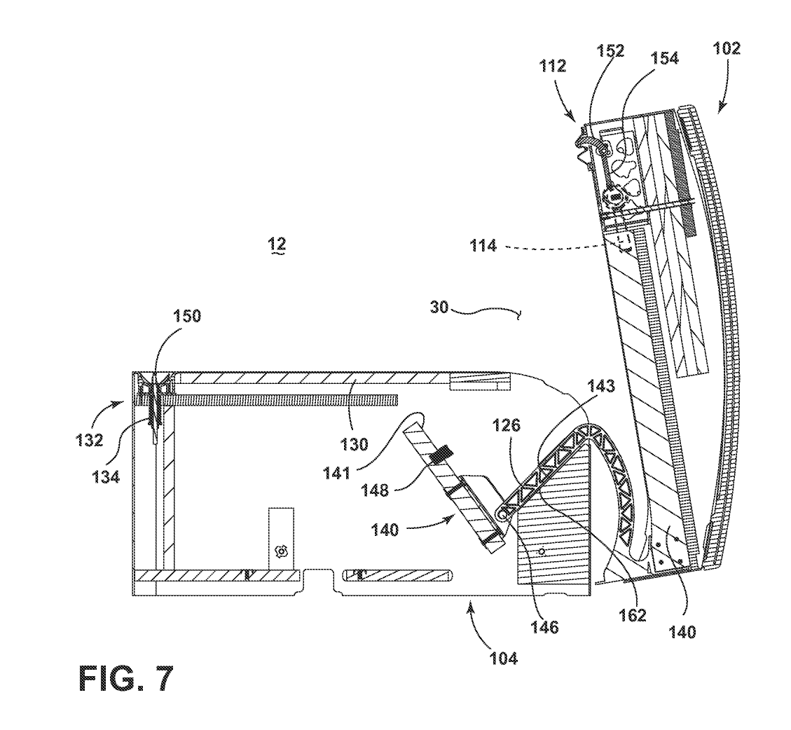

When the latching mechanism upper portion 112 is disengaged from the latching mechanism lower portion 132, the arm rest 22 is rotatable to the fully open position as illustrated in FIG. 7. During rotation, the arm rest 22 remains in the same plane as the arm base 24. In the fully open position, the connecting arm 126 abuts the open position retaining surface 143 of the pivot arm retainer 140, positioning the arm rest 22 substantially behind arm base 24 and forming a transfer gap 30 between the arm rest 22 and arm base 24. The reader is reminded that the transfer gap 30 is defined by the upper surface of the chair seat 18 which is above the arm base 24 and the front surface of the chair back 18 which is in front of the arm rest. This allows for a person seated in the chair to be transferred to another device, such as a wheelchair, positioned adjacent to chair 10 without interference from any portion of the supporting side 22 and with minimal gap between the chair 10 and the adjacent device. Furthermore, a cleaning gap 158 is formed between a rear side of the arm base 24 and the arm rest 22.

The embodiments of the invention provide for a plurality of benefits including that the arm rest 22 of the chair 10 is movable between a closed position and a fully open position in the same plane. In the closed position, the arm rest 22 may be securely engaged with the arm base 24 to provide a person in the chair 10 with arm support and prevent a person from accidently moving the arm rest 22. In the open position, the arm rest 22 is disposed behind the front surface of the chair back 16 and the arm base upper surface 32 is positioned below the chair seat 18, allowing a person in the chair to be transferred to another device by moving horizontally over the arm base 24. By allowing the arm rest 22 to rotate about the arm base 24 while remaining in the same plane as the arm base 24, the chair requires minimal clearance between other objects to rotate the arm rest 22 to the open position. For example, the chair may be positioned directly next to another device, such as a wheelchair, and the arm rest 22 may still rotate to the open position. This allows the person in the chair to be transferred directly the other device without secondary movement of the chair or other device after the arm rest 22 is moved to the open position. Furthermore, by providing a biasing spring 148 in connection with the arm rest 22, the arm rest 22 moves to a rotation indication position when the arm rest 22 is disengaged from the arm base 24. This provides a visual indication that the arm rest is not engaged with the arm base 24 to increase the safety and user friendliness of the chair.

While the invention has been specifically described in connection with certain specific embodiments thereof, it is to be understood that this is by way of illustration and not of limitation. Reasonable variation and modification are possible with the scope of the foregoing disclosure and drawings without departing from the spirit of the invention which, is defined in the appended claims. Hence, specific dimensions and other physical characteristics relating to the embodiments disclosed herein are not to be considered as limiting, unless the claims expressly state otherwise.

1. A transfer chair comprising:
a base,
supporting sides disposed on opposite sides of the base and which extend upward from the base,
a chair seat extending between the supporting sides, and
a chair back extending upwardly from a rear of seat,
wherein at least one of the supporting sides has an arm base securely fastened to the base with an arm base upper surface disposed beneath a top surface of the seat, and an arm rest with an arm rest lower surface, the arm rest rotatably mounted to the arm base such that the arm rest may be selectively rotated in the same plane as the arm base between a closed position where the arm rest lower surface engages the arm base upper surface, and a fully open position where the arm rest lower surface is disposed behind a front surface of the chair back.

2. A transfer chair according to claim 1 further comprising a latching mechanism to selectively secure the arm base and arm rest together in the closed position.

3. A transfer chair according to claim 2 wherein the latching mechanism has a first portion disposed in the arm rest and a second portion disposed in the arm base.

4. A transfer chair according to claim 2 wherein the arm rest has a lever operably coupled to the latching mechanism to selectively allow the arm rest to rotate.

5. A transfer chair according to claim 4 wherein the latching mechanism has a first portion disposed in the arm rest and a second portion disposed in the arm base and when the lever is in a first position the first portion of the latching mechanism is securely engaged with the second portion of the latching mechanism at a front portion of arm base.

6. A transfer chair according to claim 5 wherein when the lever is rotated to a second position, the first portion of the latching mechanism disengages the second portion of the latching mechanism, decoupling the arm rest and the arm base at a front portion thereof.

7. A transfer chair according to claim 6 wherein when the lever is rotated to the second position, the arm rest moves to a rotation indicating position wherein an indicating gap is formed between the arm rest and the arm base at a front portion thereof.

8. A transfer chair according to claim 2 further comprising a spring in the latching mechanism to bias the arm rest toward the closed position.

9. A transfer chair according to claim 1 further comprising at least one biasing member between the arm base and the arm rest to bias the arm rest away from the closed position.

10. A transfer chair comprising:
a chair seat between opposing sides of a base,
a chair back extending upwardly from a rear of seat, and
an arm mounted to the base on each opposing side;
wherein at least one arm is rotatably mounted such that the arm may be selectively rotated parallel to one of the opposing side between a closed position where the arm is generally parallel to and adjacent the seat, and a fully open position where the arm is disposed behind a front surface of the chair back.

11. A transfer chair according to claim 10 further comprising a latching mechanism to selectively secure the at least one arm in the closed position.

12. A transfer chair according to claim 11 further comprising a spring in the latching mechanism to bias the arm toward the closed position.

13. A transfer chair according to claim 10 wherein the arm has a lever operably coupled to the latching mechanism to selectively allow the arm to rotate.

14. A transfer chair according to claim 10 further comprising at least one biasing member to bias the arm away from the closed position.
